(19) United States
(12) Patent Application Publication
(10) Pub. No.: US 2023/0235102 A1
(43) Pub. Date: Jul. 27, 2023

(54) A ZIEGLER-NATTA CATALYST SYSTEM AND A PROCESS OF POLYMERISATION THEREFROM

(71) Applicant: Reliance Industries Limited, Mumbai (IN)

(72) Inventors: Virendrakumar Gupta, Navi Mumbai (IN); Parthiv Mukundkumar Trivedi, Dombivali (IN)

(73) Assignee: Reliance Industries Limited, Mumbai (IN)

(21) Appl. No.: 18/003,450

(22) PCT Filed: Jun. 26, 2021
(86) PCT No.: PCT/IB2021/055724

§ 371 Date: Dec. 27, 2022

(30) Foreign Application Priority Data
Jun. 26, 2020 (IN) 202021027295

(51) Int. Cl. C08F 10/06; C08F 4/642; C08F 10/02

(52) U.S. Cl. CPC C08F 10/06; C08F 4/6425; C08F 10/02; C08F 2410/01

(57) ABSTRACT

The present disclosure relates to a Ziegler-Natta catalyst system comprising a pro-catalyst, a co-catalyst and a selectivity control agent. The pro-catalyst comprises a magnesium compound, a titanium compound and a multi-dentate internal donor, wherein the internal donor is tetraethyl 3,3,3′,3′-tetramethyl-2,2′,3,3′-tetrahydro-1,1′-spirobiindane-5,5′,6,6′-tetracarbonate. The present disclosure further relates to a process for polymerization of an olefin using the Ziegler-Natta catalyst system. The Ziegler-Natta catalyst system of the present disclosure shows very high hydrogen response and thus can be used to produce low to high molecular weight polyolefin.

### FIELD

The present disclosure relates to a Ziegler-Natta catalyst system and a process of polymerization therefrom.

### BACKGROUND

The background information herein below relates to the present disclosure but is not necessarily prior art.

Ultra-high molecular weight (UHMW) polymers have a variety of important commercial uses. For example, UHMW polyethylene (UHMWPE) may be useful in products including ballistic protection fabrics, medical applications and microporous films. Similarly, UHMW polypropylene (UHMWPP) has been found to be convenient in the form of gel spun high melting and high strength fibers, as additives for production of microporous films. Also, low molecular weight polyproline is required for automobile applications.

Polyolefins with varied molecular weights are required for different end applications. Different catalyst systems are used for producing low and high molecular weight polymers. Further, the conventional process for preparing polyolefins is cracking of polymers to get the desired low molecular weight polymers. However, cracking leads to undesired molecular weight distribution products as well as formation of by-products.

Therefore, there is felt a need for an alternative catalyst system that mitigates the aforestated drawbacks.

### OBJECTS

Some of the objects of the present disclosure, which at least one embodiment herein satisfies, are as follows.

It is an object of the present disclosure to ameliorate one or more problems of the prior art or to at least provide a useful alternative.

Another object of the present disclosure is to provide a Ziegler-Natta catalyst system for producing low to high molecular weight polymers.

Still another object of the present disclosure is to provide a Ziegler-Natta catalyst system that is cost efficient and economical.

Yet another object of the present disclosure is to provide a process of polymerization of olefins by using Ziegler-Natta catalyst system.

Other objects and advantages of the present disclosure will be more apparent from the following description, which is not intended to limit the scope of the present disclosure.

### SUMMARY

The present disclosure relates to a Ziegler-Natta catalyst system comprising 2 wt % to 10 wt % of a pro-catalyst with respect to the total weight of the catalyst system, 83 wt % to 95 wt % of a co-catalyst with respect to the total weight of the catalyst system and 1 wt % to 8 wt % of a selectivity control agent with respect to the total weight of the catalyst system. The pro-catalyst comprises a magnesium compound, a titanium compound and a multi-dentate internal donor, wherein the internal donor is tetraethyl 3,3,3′,3′-tetramethyl-2,2′,3,3′-tetrahydro-1,1′-spirobiindane-5,5′,6,6′-tetracarbonate. The present disclosure further relates to a process for preparing a Ziegler-Natta catalyst system, wherein the process comprises a step of adding a pro-catalyst containing multi-dentate internal donor to at least one co-catalyst and at least one selectivity control agent to obtain the Ziegler-Natta catalyst system. The present disclosure further relates to a process for polymerization of an olefin using the Ziegler-Natta catalyst system. The process comprises a step of adding a Ziegler-Natta catalyst system comprising a pro-catalyst, a co-catalyst and a selectivity control agent in a hydrocarbon fluid medium to a reactor under inert atmosphere to obtain a first slurry. An olefin is introduced into the reactor containing the first slurry at a first predetermined pressure to obtain a second slurry. The second slurry is then subjected to polymerization at a predetermined temperature and at a second predetermined pressure followed by adding a chain terminating agent to obtain a polyolefin.

### DETAILED DESCRIPTION

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

Polyolefins with varied molecular weights are required for different end applications. Different catalyst systems are used for producing low and high molecular weight polymers. Further, the conventional process for preparing polyolefins is cracking of polymers to get the desired low molecular weight polymers. However, cracking leads to undesired molecular weight distribution products as well as formation of by-products.

The present disclosure provides a high hydrogen response catalyst system, which can also produce low to high molecular weight polymers using same catalyst system.

The present disclosure provides a Ziegler-Natta catalyst system which comprises a unique multi-dentate internal donor for olefin polymerization.

In a first aspect, the present disclosure provides a Ziegler-Natta catalyst system comprising 2 wt % to 10 wt % of a pro-catalyst with respect to the total weight of the catalyst system, 83 wt % to 95 wt % of a co-catalyst with respect to the total weight of the catalyst system and 1 wt % to 8 wt % of a selectivity control agent with respect to the total weight of the catalyst system. The pro-catalyst comprises a magnesium compound, a titanium compound and a multi-dentate internal donor.

In accordance with the present disclosure, the internal donor is tetraethyl 3,3,3′,3′-tetramethyl-2,2′,3,3′-tetrahydro-1,1′-spirobiindane-5,5′,6,6′-tetracarbonate. Structure of tetraethyl-3,3,3′,3′-tetramethyl-2,2′,3,3′-tetrahydro-1,1′-spirobiindane-5,5′,6,6′-tetracarbonate is as shown below.

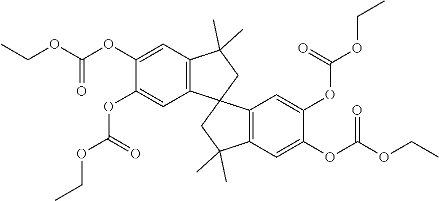 [SMILES: CCOC(=O)Oc1cc2c(cc1OC(=O)OCC)C1(CC2(C)C)CC(C)(C)c2cc(OC(=O)OCC)c(OC(=O)OCC)cc21]

The magnesium compound is at least one selected from the group consisting of magnesium chloride (MgCl₂), magnesium hydroxide (Mg(OH)₂) and magnesium alkoxide (Mg(OR)₂). In an embodiment of the present disclosure, the magnesium alkoxide is at least one selected from the group consisting of magnesium methoxide, magnesium ethoxide, magnesium iso-propoxide, magnesium n-butoxide and magnesium phenoxide. In an exemplary embodiment of the present disclosure, the magnesium compound is magnesium ethoxide.

The titanium compound is at least one selected from the group consisting of titanium halides. In an embodiment of the present disclosure, titanium halide is titanium tetrachloride.

In accordance with the present disclosure, the co-catalyst is at least one selected from the group consisting of methylaluminoxane (MAO), tri-ethyl aluminum (TEAL), tri-isobutyl aluminum (TIBAL) and di-ethyl aluminum chloride (DEAC). In an exemplary embodiment In accordance with the present disclosure, of the present disclosure, the co-catalyst is tri-ethyl aluminum (TEAL).

In accordance with the present disclosure, the selectivity control agent is at least one selected from the group consisting of cyclohexyl methyl dimethoxysilane, cyclohexyl methyl trimethoxysilane, ethyl-4-ethoxy benzoate, cyclophenyl methyl dimethoxysilane, cyclophenyl methyl trimethoxysilane and dicyclopentyl dimethoxysilane. In an exemplary embodiment of the present disclosure, the selectivity control agent is dicyclopentyl dimethoxysilane.

In accordance with the present disclosure, the pro-catalyst comprises 5 to 10 wt % of internal donor with respect to the total weight of the pro-catalyst. In an embodiment of the present disclosure, the pro-catalyst comprises 6-8 wt % of internal donor with respect to the total weight of the pro-catalyst. In an exemplary embodiment of the present disclosure, the pro-catalyst contains 7.52 wt % of internal donor with respect to the total weight of the pro-catalyst.

In accordance with the present disclosure, a molar ratio of the co-catalyst to the pro-catalyst is in the range of 200-300; and a molar ratio of the co-catalyst to the selectivity control agent is in the range of 20-40. In an exemplary embodiment of the present disclosure, the molar ratio of the co-catalyst to the pro-catalyst is 250; and a molar ratio of the co-catalyst to the selectivity control agent is 30.

In an embodiment of the present disclosure, the Ziegler-Natta catalyst system comprises 3-8 wt % of the pro-catalyst with respect to the total weight of the catalyst system, 85-94 wt % of the co-catalyst with respect to the total weight of the catalyst system and 3-7 wt % of the selectivity control agent with respect to the total weight of the catalyst system.

In a second aspect, the present disclosure provides a process for preparing a Ziegler-Natta catalyst system. The process comprises a step of adding a pro-catalyst containing multi-dentate internal donor to at least one co-catalyst and at least one selectivity control agent to obtain the Ziegler-Natta catalyst system.

In a third aspect, the present disclosure provides a process for polymerization of an olefin using the Ziegler-Natta catalyst system. The process comprises a step of adding a Ziegler-Natta catalyst system comprising a pro-catalyst, a co-catalyst and a selectivity control agent in a hydrocarbon fluid medium to a reactor under inert atmosphere to obtain a first slurry.

In an embodiment of the present disclosure, the hydrocarbon fluid medium is at least one selected from the group consisting of pentane, n-hexane, cyclohexane, methyl cyclohexane, heptane, octane, nonane, decane and isopentane. In an exemplary embodiment of the present disclosure, the hydrocarbon fluid medium is n-hexane.

An olefin is introduced into the reactor containing the first slurry at a first predetermined pressure to obtain a second slurry.

In an embodiment of the present disclosure, the olefin is selected from the group consisting of ethylene and propylene. In an exemplary embodiment of the present disclosure, the olefin is ethylene. In another exemplary embodiment of the present disclosure, the olefin is propylene.

In an embodiment of the present disclosure, the first predetermined pressure is in the range of 4.0 kg/cm² to 6.0 kg/cm². In an exemplary embodiment of the present disclosure, the first predetermined pressure is 5.0 kg/cm².

The second slurry is then subjected to polymerization at a predetermined temperature and at a second predetermined pressure followed by adding a chain terminating agent to obtain a polyolefin.

In an embodiment of the present disclosure, the chain terminating agent is hydrogen.

In an embodiment of the present disclosure, the predetermined temperature is in the range of 65° C. to 75° C. In an exemplary embodiment of the present disclosure, the predetermined temperature is 70° C.

In an embodiment of the present disclosure, the second predetermined pressure is in the range of 4.0 kg/cm² to 6.0 kg/cm². In an exemplary embodiment of the present disclosure, the second predetermined pressure is 5.0 kg/cm².

In an embodiment of the present disclosure, the process for preparing polyethylene comprises a step of adding a Ziegler-Natta catalyst system comprising a pro-catalyst, a co-catalyst and a selectivity control agent in a n-hexane to a reactor under inert atmosphere to obtain a first slurry. Ethylene gas is introduced into the reactor containing the first slurry at a pressure of 5.0 kg/cm² to obtain a second slurry. The second slurry is then subjected to polymerization at 70° C. and 5.0 kg/cm² pressure followed by adding hydrogen as a chain terminating agent to obtain polyethylene.

In another embodiment of the present disclosure, the process for preparing polypropylene comprises a step of adding a Ziegler-Natta catalyst system comprising a pro-catalyst, a co-catalyst and a selectivity control agent in a n-hexane to a reactor under inert atmosphere to obtain a first slurry. Propylene gas is introduced into the reactor containing the first slurry at a pressure of 5.0 kg/cm² to obtain a second slurry. The second slurry is then subjected to polymerization at 70° C. and 5.0 kg/cm² pressure followed by adding hydrogen as a chain terminating agent to obtain polypropylene.

In an embodiment of the present disclosure, the polyolefin is ultra-high molecular weight polyethylene (UHMWPE) and ultra-high molecular weight polypropylene (UHMWPP). In an exemplary embodiment of the present disclosure, the polyolefin is UHMWPE. In another exemplary embodiment of the present disclosure, the polyolefin is UHMWPP.

In an embodiment of the present disclosure, the UHMWPE is characterized by having an average molecular weight in the range of 0.2 million to 5.5 million, a molecular weight distribution in the range of 5 to 12, bulk density in the range of 0.25 to 0.39 g/cc and melt flow index (MFI) in the range of 0.05 to 10 g/min measured with a load of 21.6 kg at 190° C.

In an embodiment of the present disclosure, the UHMWPP is characterized by having an average molecular weight of 1 million, a molecular weight distribution in the range of 3 to 13, bulk density in the range of 0.23 to 0.30 g/cc and MFI in the range of 0.1 to 36 g/min measured with a load of 2.16 kg at 230° C.

The present disclosure further provides a process for preparation of UHMWPP fiber. The process comprises the steps of preparing gel and spinning the gel followed by hot stretching to obtain the fibers. The UHMWPP fiber diameters are measured at different stretching ratios. Also, Young's modulus is calculated for the UHMWPP fiber.

The inventors of the present disclosure, invented a Ziegler-Natta catalyst system, which comprises unique multi-dentate internal donor (i.e. tetraethyl-3,3,3′,3′-tetramethyl-2,2′,3,3′-tetrahydro-1,1′-spirobiindane-5,5′,6,6′-tetracarbonate) along with other components for olefin polymerization. Such multi-dentate catalyst system produces low to high molecular weight polyolefin having M.W. in the range of 1 million to 5.5 million Moreover, the developed Ziegler-Natta catalyst system has excellent hydrogen response which provides polypropylene having high MFI grade.

The internal donor plays a crucial role in olefin polymerization and on the activity of the catalyst. The presence of internal donor controls the tacticity of the polymer and the Molecular weight characteristics that have direct effect on the polymer processing and mechanical properties of polymer.

The catalyst system of the present disclosure employs inexpensive and easily available reagents. Thus, the process of the present disclosure is economical.

The process of the present disclosure is carried out at ambient temperatures. Thus, the process of the present disclosure is energy efficient.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### EXPERIMENTAL DETAILS

### Experiment 1: Preparation of Ziegler-Natta Pro-Catalyst

### Example 1

The magnesium alkoxide (10 gm) precursor as described in U.S. Pat. No. 8,633,124B2 was added with an equal volume of 230 ml TiCl₄ and chlorobenzene to a reactor under nitrogen atmosphere at 10° C. to obtain a mixture. The mixture was kept at 10° C. for 10 minutes to obtain a cooled mixture. 7.0 g of tetraethyl 3,3,3′,3′-tetramethyl-2,2′,3,3′-tetrahydro-1,1′-spirobiindane-5,5′,6,6′-tetracarbonate (internal donor) was added to the cooled mixture and stirred at 110° C. for 60 minutes to obtain the reaction mixture (I stage of catalyst preparation). The solid substance present in the reaction mixture was allowed to settle to obtain the separated layer of supernatant. The supernatant layer was removed by decanting to obtain the first reaction mass. To the so obtained reaction mass, a mixture of titanium tetrachloride (115 ml) and chlorobenzene (115 ml) was added followed by stirring at 110° C. for 30 minutes to obtain the second reaction mass (II stage of catalyst preparation). The solid substance present in the second reaction mass was allowed to settle to obtain the separated layer of supernatant. The supernatant layer was removed by decanting followed by adding the mixture of titanium tetrachloride (115 ml) and chlorobenzene (115 ml) along with 0.6 ml benzoyl chloride and stirring at 110° C. for 30 minutes to obtain the third reaction mass (III stage of catalyst preparation). The solid substance present in the third reaction mass was allowed to settle to obtain the separated layer of supernatant. The supernatant layer was removed by decanting to obtain a product mixture containing the pro-catalyst. After three-stage treatment the solid pro-catalyst was filtered and was given four washes with 100 ml n-hexane each and then it was dried at 50° C. under the stream of nitrogen to obtain the brown colored pro-catalyst. The compositional analysis of the pro-catalyst is summarized in Table-t.

TABLE 1
Compositional analysis and characterization of the Ziegler-Natta pro-catalyst

| | Chemical Composition | | | | | | | | | |
|---|---|---|---|---|---|---|---|---|---|---|
| Catalyst | Ti | Mg | Cl⁻ | OMe | OEt | ID | Particle size distribution (PSD) (μm) | | | |
| Code | (wt %) | (wt %) | (wt %) | (wt %) | (wt %) | (wt %) | D10 | D50 | D90 | Dmean |
| ZN-01 | 4.13 | 12.87 | 49.6 | 0.26 | 1.02 | 7.52 | 9 | 34 | 49 | 33 |

### Experiment 2: Process of Polymerization

### Examples 2-5: Polymerisation of Propylene Using the Ziegler-Natta Catalyst System

The procatalyst (0.07 g) of example 1 was mixed with TEAL (triethyl aluminium) (10% in n-hexane solution) co-catalyst (21 ml), such that the TEAL/Ti molar ratio becomes 250 and dicyclopentyl dimethoxysilane (5% in n-decane solution) (2.3 ml) as a SCA, such that the Al/SCA molar ratio becomes 30 to obtain the Zieglar Natta (ZN) catalyst system. The catalyst system was added to the reactor containing n-hexane (2000 ml) under inert atmosphere to obtain a first slurry. Propylene gas at a pressure of 5.0 kg/cm² was introduced to the reactor containing the first slurry to obtain a second slurry. The second slurry was then subjected to polymerization and the reactor pressure was maintained to 5.0 kg/cm² and the reactor temperature was maintained to 70° C. followed by addition of hydrogen [0 ml, 1 kg/cm² (300 ml), 2 kg/cm² (600 ml) and 3 kg/cm² (900 ml)] to terminate the polymerization to obtain polypropylene of desired molecular weight.

### Comparative Example: Polymerisation of Propylene Using the Ziegler-Natta Catalyst System

Same experimental procedure was followed as described in Example 2, except that the Ziegler-Natta catalyst having known internal donor i.e. diester diisobutyl phthalate (DIBP) was used.

The polymerization was performed with different hydrogen concentration (1 kg/cm², 2 kg/cm² and 3 kg/cm²) and also without H₂ to study the melt flow index (MFI). The productivity of the catalyst, bulk density (BD), xylene soluble content, average particle size, melt flow index, Mw and polydispersity index (PDI) of the polypropylene are given in Table 2.

TABLE 2
Propylene Polymerization performance and product Characteristics

| | | Productivity | Xylene | | MFI | | |
|---|---|---|---|---|---|---|---|
| PP | Hydrogen | (Kg PP/ | soluble | BD | (2.16 Kg load | Mw | |
| samples | Kg/Cm² | g cat) | (%) | (T) | and 230° C.) | g/mol | PDI |
| Ex-2 | 0 | 0.8 | 3.3 | 0.29 | 0.1 | 12.1 × 10⁵ | 7.3 |
| Ex-3 | 1 | 2.0 | 3.4 | 0.28 | 5.2 | 5.3 × 10⁵ | 5.2 |
| Ex-4 | 2 | 1.3 | 3.2 | 0.28 | 16.8 | 3.3 × 10⁵ | 4.6 |
| Ex-5 | 3 | 2.8 | 3.5 | 0.29 | 36.0 | 1.8 × 10⁵ | 3.5 |
| Comparative | 0 | 0.7 | 4.3 | 0.35 | 0.1 | 0.9 × 10⁵ | 10.6 |
| example | | | | | | | |

From Table 2, it is observed that the Ziegler Natta pro-catalyst of the present disclosure showed high productivity (˜1-2.8 Kg PP/g cat). However, the comparative example in which diester diisobutyl phthalate (DIBP) was used as internal donar, shows comparatively lower productivity (0.7 Kg PP/g cat). Further, the increasing concentration of chain terminating agent (hydrogen) increases the MFI and decreases the molecular weight of polypropylene. This indicates that the catalyst system of the present disclosure shows higher hydrogen response. Thus, by varying the concentration of the chain terminating agent, polypropylene with desired molecular weight can be produced by using the same catalyst.

### Examples 6-9: Polymerisation of Ethylene Using the Ziegler-Natta Catalyst System

Same experimental procedures were followed as described in Examples 2-5 respectively, except that the ethylene was used and dicyclopentyl dimethoxysilane was not used.

The polymerization was performed with different hydrogen concentration (1 kg/cm², 2 kg/cm² and 3 kg/cm²) and also without H₂ to study the melt flow index (MFI). The productivity of the catalyst, bulk density (BD), average particle size, melt flow index and Mw of the polypropylene are given in Table 3.

TABLE 3
Ethylene polymerization performance and product characteristics

| | | | | MFI | |
|---|---|---|---|---|---|
| | | Activity | BD | (21.6 Kg load | |
| PE | Hydrogen | (Kg PE/ | (T) | and 90° C.) | Mw by IV |
| Examples | Kg/Cm² | g cat) | g/cc | g/10 min | Mᵥ(g/mol) |
| Ex-6 | 0 | 14.3 | 0.31 | 0.19 | 51.0 × 10⁵ |
| Ex-7 | 1 | 12.5 | 0.36 | 1.1 | 4.1 × 10⁵ |
| Ex-8 | 2 | 12.4 | 0.34 | 2.1 | 3.6 × 10⁵ |
| Ex-9 | 3 | 10.1 | 0.29 | 8.0 | 2.2 × 10⁵ |

From Table 3, it is observed that the Ziegler Natta pro-catalyst of the present disclosure showed very high productivity (˜10-14.5 Kg PE/g cat). Further, the increasing concentration of chain terminating agent (hydrogen) increases the MFI and decreases the molecular weight of polyethylene. This indicates that the catalyst system of the present disclosure shows higher hydrogen response. Thus, by varying the concentration of the chain terminating agent, polypropylene with desired molecular weight can be produced by using the same catalyst.

### Experiment 3: Preparation of UHMWPP Fiber

### Gel-Preparation:

UHMWPP obtained in examples 2 with an average molecular weight 1.2 million polymer resin (70 g) was dissolved in 1000 ml decalin along with 0.7 g Irganox 1010 (N, N′-1,6-hexanediylbis[3,5-bis-4-hydroxyphenylpropanamide]) and 0.7 g Irgafox 168 (Tris(2,4-di-tert.-butylphenyl)phosphite) stabilizers by stirring in a reactor for 1 hr at 150° C. to obtain a homogenous solution. The solution was then cooled to room temperature in the reactor to obtain the gel and then transferred for spinning

### Gel-Spinning:

A four-zone screw extruder was used for spinning the gel. The gel was passed through the zones with adequate heating to obtain spinning solution. After extrusion, the preheated spinning solution was passed through a conical spinning hole die and was crystallized by cooling, thus resulting in the formation of UHMWPP fibers. The fiber extrusion speed was set up to 5 rpm. The UHMWPP fibers extrusion were freely extruded into 20 cm air gap and quenched into water bath and simultaneously passed through stretching roller and quenching water bath. The stretching speed of each roller was set up such that the fiber would not break during spinning After successful spinning, the fiber was collected on single head winder for further processing and hot stretching.

### Hot Stretching:

Hot stretching was performed using heated godets. The godet speed was set up in such a way that the fiber would not break during hot stretching. The fiber drawing was done with different draw ratios for each run—1:2, 1:5, and 1:8 and 1:10. The draw ratio as used here is defined as the ratio of the collection roller speed to the feed roller speed. All the godets were heated to 150° C. so as not to melt the fibers during the process.

Cycle S1 corresponds to the stretching ratio of 1:2 times. Similarly, S2 corresponds to 1:5 times, and S3 and S4 correspond to 1:8 and 1:10 hot stretching respectively. The fiber diameter was measured by a microscope (FESEM) prior to testing and was used for the calculation of tensile strength. The diameter and Young's modulus of the UHMWPP fiber at different stretching ratio are given in Table 4.

TABLE 4
Properties of UHMWPP fibers

| Sample Code | Stretching Ratio | Young's Modulus (MPa) |
|---|---|---|
| S1 | 1:2 | 247 |
| S2 | 1:5 | 118 |
| S3 | 1:8 | 318 |
| S4 | 1:10 | 784 |

From Table 4, it is observed that S4 corresponding to a draw/stretching ratio 1:10, has the highest Young's Modulus (784 MPa) for hot stretched UHMWPP fiber. The draw ratio or stretching ratio of the polymer in fiber preparation process, aligns the polymer chains in unidirectional pattern due to which the mechanical strength gets increased. Therefore, it is evident that the modulus increases with increase in stretching ratio as shown in Table 4. However, after certain extent of stretching there will not be any change in mechanical properties and there will be difficulty in stretching the fiber which may lead to breakdown of fibers.

### TECHNICAL ADVANCEMENTS

The present disclosure described herein above has several technical advantages including, but not limited to, the realization of a Ziegler-Natta catalyst system which:
produces low to high molecular weight polyolefin;
shows very high hydrogen response; and
is cost efficient and economical.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein.

Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A Ziegler-Natta catalyst system comprising:
2 wt % to 10 wt % of a pro-catalyst with respect to the total weight of the catalyst system;
wherein said pro-catalyst comprises;
a magnesium compound;
a titanium compound; and
a multi-dentate internal donor;
83 wt % to 95 wt % of a co-catalyst with respect to the total weight of the catalyst system; and
1 wt % to 8 wt % of a selectivity control agent with respect to the total weight of the catalyst system.

2. The catalyst system as claimed in claim 1, wherein said multi-dentate internal donor is tetraethyl 3,3,3′,3′-tetramethyl-2,2′,3,3′-tetrahydro-1,1′-spirobiindane-5,5′,6,6′-tetracarbonate.

3. The catalyst system as claimed in claim 1, wherein said magnesium compound is at least one selected from the group consisting of magnesium chloride (MgCl₂), magnesium hydroxide (Mg(OH)₂) and magnesium alkoxide (Mg(OR)₂).

4. The catalyst system as claimed in claim 3, wherein said magnesium alkoxide is at least one selected from the group consisting of magnesium methoxide, magnesium ethoxide, magnesium iso-propoxide, magnesium n-butoxide and magnesium phenoxide.

5. The catalyst system as claimed in claim 1, wherein said titanium compound is titanium halides.

6. The catalyst system as claimed in claim 5, wherein said titanium halide is titanium tetrachloride.

7. The catalyst system as claimed in claim 1, wherein said co-catalyst is at least one selected from the group consisting of methyl aluminoxane (MAO), tri-ethyl aluminum (TEAL), tri-isobutyl aluminum (TIBAL) and di-ethyl aluminum chloride (DEAC).

8. The catalyst system as claimed in claim 1, wherein said selectivity control agent is at least one selected from the group consisting of cyclohexyl methyl dimethoxysilane, cyclohexyl methyl trimethoxysilane, ethyl-4-ethoxy benzoate, cyclophenyl methyl dimethoxysilane, and cyclophenyl methyl trimethoxysilane.

9. The catalyst system as claimed in claim 1, wherein said pro-catalyst comprises 5 to 10 wt % of multi-dentate internal donor with respect to the total weight of the pro-catalyst.

10. The catalyst system as claimed in claim 1, wherein a molar ratio of said co-catalyst to said pro-catalyst is in the range of 200-300; and a molar ratio of said co-catalyst to said selectivity control agent is in the range of 20-40.

11. The catalyst system as claimed in claim 1, wherein a molar ratio of said co-catalyst to said pro-catalyst is 250; and a molar ratio of said co-catalyst to said selectivity control agent is 30.

12. The catalyst system as claimed in claim 1, comprises:
3-8 wt % of said pro-catalyst with respect to the total weight of the catalyst system; wherein said pro-catalyst comprises 5-10 wt % of internal donor with respect to the total weight of the pro-catalyst.
85-94 wt % of said co-catalyst with respect to the total weight of the catalyst system; and
3-7 wt % of said selectivity control agent with respect to the total weight of the catalyst system.

13. A process for preparing a Ziegler-Natta catalyst system, said process comprises a step of adding a pro-catalyst containing multi-dentate internal donor to at least one co-catalyst and at least one selectivity control agent to obtain the Ziegler-Natta catalyst system.

14. A process for polymerization of an olefin using a Ziegler-Natta catalyst system; said process comprising the following steps:
adding a Ziegler-Natta catalyst system comprising a pro-catalyst, a co-catalyst and a selectivity control agent; and a hydrocarbon fluid medium
in a reactor under inert atmosphere to obtain a first slurry;
introducing an olefin into the reactor containing said first slurry at a first predetermined pressure to obtain a second slurry;
subjecting said second slurry to polymerization at a predetermined temperature and at a second predetermined pressure followed by adding a chain terminating agent to obtain a polyolefin.

15. The process as claimed in claim 14, wherein said hydrocarbon fluid medium is at least one selected from the group consisting of pentane, n-hexane, cyclohexane, methyl cyclohexane, heptane, octane, nonane, decane and isopentane.

16. The process as claimed in claim 14, wherein said chain terminating agent is hydrogen.

17. The process as claimed in claim 14, wherein said predetermined temperature is in the range of 65° C. to 75° C.

18. The process as claimed in claim 14, wherein said first and second predetermined pressure is in the range of 4.0 kg/cm² to 6.0 kg/cm².

19. A process for preparing polyethylene as claimed in claim 14, wherein said process comprising the following steps:
adding
a Ziegler-Natta catalyst system comprising a pro-catalyst, a co-catalyst and a selectivity control; and
n-hexane
in a reactor under inert atmosphere to obtain a first slurry;
introducing ethylene gas at a pressure of 5.0 kg/cm² into the reactor containing said first slurry to obtain a second slurry;
subjecting said second slurry to polymerization at 70° C. and 5.0 kg/cm² pressure followed by adding hydrogen as a chain terminating agent to obtain polyethylene.

20. A process for preparing polypropylene as claimed in claim 14, wherein said process comprising the following steps:
adding
a Ziegler-Natta catalyst system comprising a pro-catalyst, a co-catalyst and a selectivity control; and
n-hexane
in a reactor under inert atmosphere to obtain a first slurry;
introducing propylene gas at a pressure of 5.0 kg/cm² into the reactor containing said first slurry to obtain a second slurry;
subjecting said second slurry to a polymerization at 70° C. and 5.0 kg/cm² pressure followed by adding hydrogen as a chain terminating agent to obtain polypropylene.
